(19) United States
(12) Patent Application Publication
(10) Pub. No.: US 2008/0121484 A1
(43) Pub. Date: May 29, 2008

(54) Torque transfer device

(75) Inventor: Mario Degler, Baden-Baden (DE)

Correspondence Address: SIMPSON & SIMPSON, PLLC, 5555 MAIN STREET, WILLIAMSVILLE, NY, 14221-5406, US

(73) Assignee: LuK Lamellen und Kupplungsbau Beteiligungs KG, Buehl (DE)

(21) Appl. No.: 11/986,429

(22) Filed: Nov. 21, 2007

(30) Foreign Application Priority Data
Nov. 29, 2006 (DE) 10 2006 056 298.4

(51) Int. Cl. F16H 45/02

(52) U.S. Cl. 192/3.28

(57) ABSTRACT

A torque transfer device for transferring torque between a drive unit and a shaft that is rotatable around an axis of rotation, in particular a transmission input shaft, having a hydrodynamic torque converter, which comprises a converter cover that is connectable to or connected to the drive unit, which converter cover may be coupled via an impeller to a turbine wheel to transfer torque, which turbine wheel is bridgeable, to transfer torque, by a torque converter lockup clutch, which includes a piston that is movable to a limited extent in the axial direction and is constructed as a multi-plate clutch with a plate pack that includes outer plates which are connected to an outer plate carrier in a rotationally fixed connection, and inner plates which are connected to an inner plate carrier in a rotationally fixed connection.

### CROSS REFERENCE TO RELATED APPLICATIONS

This patent claims priority of German Patent Application No. 10 2006 056 298.4, filed Nov. 29, 2006, which application is incorporated herein by reference.

### BACKGROUND OF THE INVENTION

The invention relates to a torque transfer device for a motor vehicle.

### SUMMARY OF THE INVENTION

The present invention relates to a torque transfer device, in particular in the power train of a motor vehicle, for transferring torque between a drive unit and a shaft that is rotatable around an axis of rotation, in particular a transmission input shaft, having a hydrodynamic torque converter, which comprises a converter cover that is connectable to or connected to the drive unit, which may be coupled via an impeller to a turbine wheel to transfer torque, which turbine wheel is bridgeable, to transfer torque, by a torque converter lockup clutch, which includes a piston that is movable to a limited extent in the axial direction and is constructed as a multi-plate clutch with a plate pack that includes outer plates which are connected to an outside plate carrier in a rotationally fixed connection, and inner plates which are connected to an inner plate carrier in a rotationally fixed connection.

The problem is solved in the case of a torque transfer device, in particular in the power train of a motor vehicle, for transferring torque between a drive unit and a shaft that is rotatable around an axis of rotation, in particular a transmission input shaft, having a hydrodynamic torque converter, which includes a converter cover that is connectable to or connected to the drive unit, which may be coupled via an impeller to a turbine wheel to transfer torque, which turbine wheel is bridgeable, to transfer torque, by a torque converter lockup clutch, which includes a piston that is movable to a limited extent in the axial direction and is constructed as a multi-plate clutch with a plate pack that includes outer plates which are connected to an outer plate carrier in a rotationally fixed connection, and inner plates which are connected to an inner plate carrier in a rotationally fixed connection, in that the plate pack has, on the side facing away from the piston, an end plate that is fixed relative to the outer plate carrier, which end plate serves to transfer torque and is tightly connected to the outer plate carrier. The fixed end plate creates in a simple manner an assemble-able torque transfer device, which in addition enables a directed flow-through of a cooling medium, such as oil, to cool the clutch plates.

A preferred exemplary embodiment of the torque transfer device is characterized in that the end plate is attached to an output part of a torsional vibration damping device, which is connected ahead of the torque converter lockup clutch. The torsional vibration damping device comprises an input part, which is preferably attached to the converter cover.

Another preferred exemplary embodiment of the torque transfer device is characterized in that the end plate is supported in the axial direction on the outer part of the torsional vibration damping device. This makes it possible to absorb and/or transfer axial forces.

Another preferred exemplary embodiment of the torque transfer device is characterized in that the end plate is connected to the outer plate carrier and/or the output part in a rotationally fixed connection. The end plate can be directly or indirectly attached to the outer plate carrier.

Another preferred exemplary embodiment of the torque transfer device is characterized in that the end plate is connected to the outer plate carrier and/or the output part by material bonding. The material-bonded connection is preferably executed as a welded connection.

Another preferred exemplary embodiment of the torque transfer device is characterized in that the end plate is connected to the outer plate carrier and/or the output part by at least one friction or laser-welded connection. The laser-welded connection can be partial or continuous.

Another preferred exemplary embodiment of the torque transfer device is characterized in that the end plate is crimped to the outer plate carrier and/or the output part. The crimped connection is produced partially or around the entire periphery, for example with a stamp.

Another preferred exemplary embodiment of the torque transfer device is characterized in that the end plate is connected to the outer plate carrier and/or the output part for example by roller burnishing. The roller burnishing can be done partially or around the entire periphery.

Another preferred exemplary embodiment of the torque transfer device is characterized in that the end plate has a profiled outer diameter. The outer diameter of the end plate is provided for example with a toothing, a wave profile or a notched profile. Preferably the output part is provided with complementary-formed toothing, a wave profile or a notched profile.

Another preferred exemplary embodiment of the torque transfer device is characterized in that the end plate is connected to the outer plate carrier and/or the output part by frictional or positive connection. Preferably, the connection is executed as a force fit. However, the connection can also be formed by beading and stamping.

Another preferred exemplary embodiment of the torque transfer device is characterized in that a gasket, in particular a plastic gasket, a paper gasket, a metal gasket or a light metal gasket is situated between the end plate and the outer plate carrier. This reliably prevents the passage of coolant.

Another preferred exemplary embodiment of the torque transfer device is characterized in that the end plate has, radially on its inner or outer embossing and/or dishing. The purpose of the embossing and/or dishing is to increase stiffness.

Another preferred exemplary embodiment of the torque transfer device is characterized in that the outer plate carrier is situated in the axial direction between the output part and the end plate. The end plate is thus supported in an axial direction by the outer plate carrier.

Another preferred exemplary embodiment of the torque transfer device is characterized in that the torsional vibration damping device includes a first torsional vibration damper which acts between the converter cover and the output part, and a second torsional vibration damper which acts between the turbine wheel and the shaft. The torsional vibration damping device is preferably constructed as a double damper.

Another preferred exemplary embodiment of the torque transfer device is characterized in that the hydrodynamic torque converter includes a three-channel system, through which the operation of the torque converter lockup clutch is controlled. The flow through each of the individual channels can be in one direction or two.

The object of the invention is to create a torque transfer device, in particular in the power train of a motor vehicle, for transferring torque between a drive unit (3) and a shaft that is rotatable around an axis of rotation (28), in particular a transmission input shaft, having a hydrodynamic torque converter (6), which comprises a converter cover (14) that is connectable to or connected to the drive unit (3), which converter cover may be coupled via an impeller (20) to a turbine wheel (21) to transfer torque, which turbine wheel is bridgeable, to transfer torque, by a torque converter lockup clutch (35), which includes a piston (64) that is movable to a limited extent in the axial direction and is constructed as a multi-plate clutch with a plate pack (80) that includes outer plates (81, 82) which are connected to an outer plate carrier (36) in a rotationally fixed connection, and inner plates (83, 84) which are connected to an inner plate carrier (34) in a rotationally fixed connection, wherein the plate pack (80) has, on the side facing away from the piston (64), an end plate (90, 100) that is fixed relative to the outer plate carrier (36), which serves to transfer torque and is tightly connected to the outer plate carrier (36). The invention is simply constructed and can be manufactured economically.

### BRIEF DESCRIPTION OF THE DRAWINGS

Additional advantages, characteristics and details of the invention are evident from the following description, in which various embodiments are described in detail with reference to the drawings, in which:

FIG. 1 is a half-sectional view of a torque transfer device according to a first exemplary embodiment; and,

FIG. 2 is a half-sectional view of a torque transfer device according to a second exemplary embodiment.

### DETAILED DESCRIPTION OF THE INVENTION

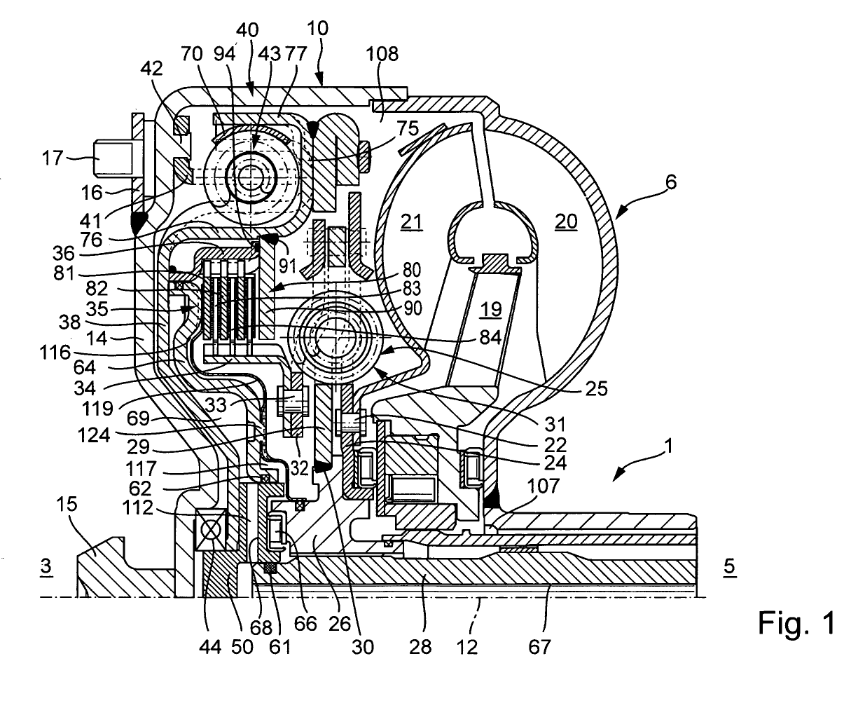

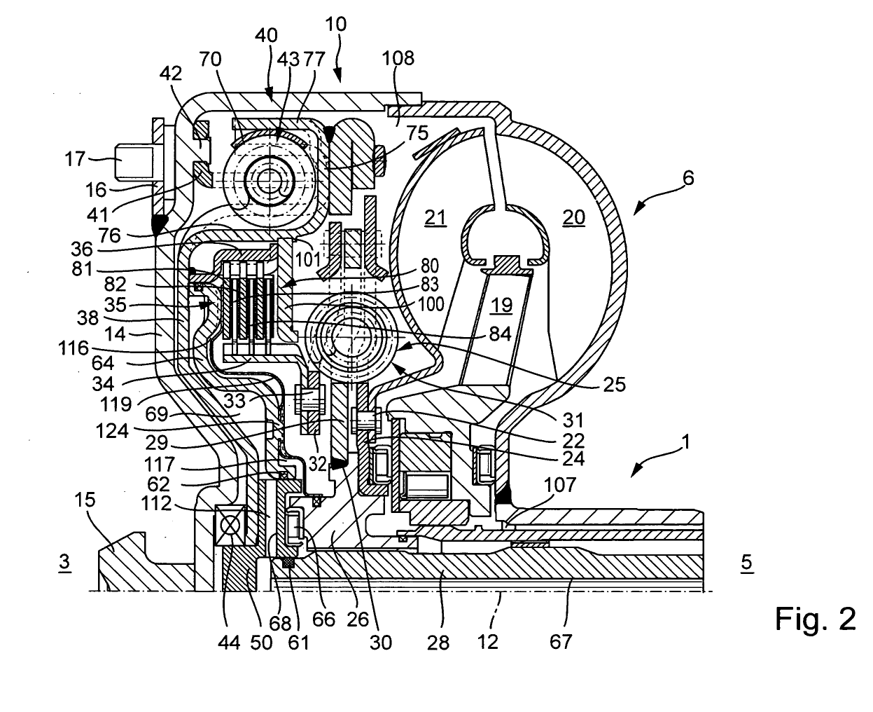

FIGS. 1 and 2 each depict part of power train 1 of a motor vehicle. Between drive unit 3, in particular a combustion engine, which is only indicated by a reference number and from which a crankshaft emerges, and transmission 5, which is also only indicated by a reference number, hydrodynamic torque converter 6 is situated. The crankshaft of combustion engine 3 is connected to housing 10 of torque converter 6 in a rotationally fixed connection, for example through a sheet metal drive plate, which is also known as a flex plate. Housing 10 of torque converter 6 is rotatable around axis of rotation 12, and is equipped with housing wall 14 close to the drive, which is also called the converter cover.

Attached to converter cover 14 is central pilot bearing pin 15, whose function is to pre-center the hydrodynamic torque converter 6 during installation in a central recess in the crankshaft. Welded radially on the outside of converter cover 14 is sheet metal linking plate 16, from which threaded bolts 17 protrude, with which converter cover 14 is attached to the sheet metal drive plate.

Hydrodynamic torque converter 6 comprises guide wheel 19, impeller 20 and turbine wheel 21. Turbine wheel 21 is firmly connected to side plate 24 by rivet fastening elements 22. Side plate 24 represents the input part of torsional vibration damper 25, which is situated in the axial direction between converter cover 14 and turbine wheel 21. Torsional vibration damper 25 includes damper hub 26, on which side plate 24 and turbine wheel 21 attached thereto are rotatably mounted radially on the outside.

Damper hub 26 is connected radially on the inside to transmission input shaft 28 in a rotationally fixed connection. The output part of torsional vibration damper 25 is formed by damper flange 29, which is firmly connected to damper hub 26 by welded seam 30. Damper flange 29 is coupled with side plate 24 and further side plate 32, with spring elements 31 interposed. Side plate 32, which represents another input part of torsional vibration damper 25, is firmly connected to inner plate carrier 34 of torque converter lockup clutch 35 in lamellar construction by rivet fastening elements 33.

Torque converter lockup clutch 35 also includes outer plate carrier 36, which is attached to output part 38 of further torsional vibration damper 40. Torsional vibration damper 40 includes input part 41, which is attached to converter cover 14 by rivet fastening elements 42. Rivet fastening elements 42 are formed by rivet bosses which protrude from converter cover 14. Input part 41 of torsional vibration damper 40 is coupled with output part 38 through spring elements 43. Situated between output part 38 of torsional vibration damper 40 and converter cover 14 is roller bearing 44, in particular a ball bearing. Output part 38 of torsional vibration damper 40 is rotatably mounted on converter cover 14 through roller bearing 44. Torsional vibration damper 40 and torsional vibration damper 25 form a double damper.

Roller bearing 44 and output part 38 of torsional vibration damper 40 are supported on hub part 50. A stepped end of transmission input shaft 28 is rotatably situated in hub part 50 and has a sealing effect. To improve the sealing effect, sealing ring 61 is partially received in an annular groove, which is formed in the stepped end of the transmission input shaft. Hub part 50 rests against sealing ring 61. A further sealing ring 62 is partially received in an annular groove which is formed on piston 64 of torque converter lockup clutch 35. Piston 64 is mounted on hub part 50 so that it is axially movable and possibly rotatable, and provides a sealing effect.

Bearing device 66 is positioned in the axial direction between hub part 50 and damper hub 26. Bearing device 66 is preferably an axial bearing, which serves to support axial forces. Alternatively or additionally, however, it can also be a radial bearing. Bearing 66 is designed for example as a journal bearing or as a roller bearing.

Transmission input shaft 28 is provided internally with central cavity 67 for feeding in or removing hydraulic medium. Cavity 67 is connected to pressure chamber 69 through flow channel 68, which extends through hub part 50 in the radial direction. Pressure chamber 69 is bounded by output part 38 of torsional vibration damper 40 and piston 64 of torque converter lockup clutch 35.

Output part 38 of torsional vibration damper 40 has, radially on its outside, an essentially U-shaped cross section, with base 75 from which two sides 76 and 77 project. Sides 76 and 77 extend in the axial direction. Base 75 extends in the radial direction. The U-shaped cross section bounds on its inside at least one receiving space for energy storage elements 43. Situated between energy storage elements 43 and side 77 is sliding shell 70.

Torque converter lockup clutch 35 shown in FIGS. 1 and 2 is constructed as a multi-plate clutch, with plate pack 80 that includes outer plates 81, 82 and inner plates 83, 84. Outer plates 81 are connected to outer plate carrier 36 in a rotationally fixed connection through outer teeth. Inner plates 83, 84 are connected to inner plate carrier 34 in a rotationally fixed connection through inner teeth.

In the exemplary embodiment depicted in FIG. 1, end plate 90 is attached to output part 38 of torsional vibration damper 40 with the help of welded connection 91. End plate 90 forms an axial stop for clutch plates 81 through 84, when these are acted on by piston 64 of torque converter lockup clutch 35. At the same time, end plate 90 is in close contact with outer plate carrier 36. The sealing effect is improved by seal 94, which is received in an annular groove of outer plate carrier 36 and is in contact with end plate 90. End plate 90 has essentially the shape of a circular disk.

In the exemplary embodiment depicted in FIG. 2, end plate 100 is fixed in the axial direction toward transmission 5 with the help of locating keys 101, which extend radially inward from output part 38 of torsional vibration damper 40. The side of end plate 100 which faces drive unit 3 rests against outer plate carrier 36, with a sealing effect. End plate 100 may be equipped with outer teeth, which interact with teeth of complementary design on output part 38 to produce a rotationally fixed connection between these two parts. End plate 100 essentially has the shape of a circular disk which has a bent down edge area on its radial inner side.

The hydrodynamic torque converter depicted in FIGS. 1 and 2 has a three-channel system. This means that a total of three channels are available to realize oil circulation and controlling of the torque converter lockup clutch 35. The oil stream for the circulation can flow in two directions. A cooling medium, in particular oil, flows from a first channel 107 initially into impeller 20, which is also referred to as a pump. One part of the oil then completes a continuation of the toroidal flow in turbine 21 and guide wheel 19. The other part of the oil emerges at the gap between impeller 20 and turbine wheel 21, and flows into the remaining space of first chamber 108 in housing 10.

A further, second channel 112, which runs from the hollow transmission input shaft 28 through flow channel 68, supplies pressure chamber 69 with oil. When oil pressure is applied to pressure chamber 69, torque converter lockup clutch 35 engages, in that piston 64 moves over to the right, and in so doing presses plates 81 to 84 against end plate 90, 100. If pressure chamber 69, which is also referred to as the second chamber, is left unpressurized or is subjected to only slight pressure, then the oil pressure from first chamber 108 disengages torque converter lockup clutch 35 again.

According to another essential aspect of the invention, end plate 90, 100 makes it essentially impossible for oil to flow between the teeth of outer plate carrier 36, which is also referred to as the outer plate carrier, and the teeth of outer plates 81, 82, because end plate 90, 100 is tightly connected to outer plate carrier 36.

Third channel 117 is connected to space 116. Space 116 extends between piston 64 and additional wall 119, which is attached to piston 64 with the help of spacing rivets 124. An annular gap between piston 64 and additional wall 119 creates a through opening for the circulating oil on the side of the outer teeth of outer plates 81, 82 facing away from turbine 21. Since additional wall 119 provides a seal with respect to the hub, no oil can flow from first space 108 into third channel 117, which is also referred to as a return line. This ensures that essentially the oil can only circulate via plates 81 to 84 or through torque converter lockup clutch 35. This improves the cooling of the friction linings of plates 81 to 84.

### REFERENCE NUMERALS

1 power train
3 drive unit
5 transmission
6 hydrodynamic torque converter
10 housing
12 axis of rotation
14 housing wall
15 pilot bearing pin
16 sheet metal linking plate
17 threaded bolt
19 guide wheel
20 impeller
21 turbine wheel
22 rivet fastening elements
24 side plate
25 torsional vibration damper
26 damper hub
28 transmission input shaft
29 damper flange
30 welded seam
31 spring elements
32 side plate
33 rivet fastening elements
34 inner plate carrier
35 torque converter lockup clutch
36 outer plate carrier
38 output part
40 torsional vibration damper
41 input part
42 rivet fastening elements
43 spring elements
44 roller bearing
50 hub part
61 sealing ring
62 sealing ring
64 piston
66 bearing device
67 hollow chamber
68 flow channel
69 pressure chamber
70 sliding shell
75 base
76 side
77 side
80 plate pack
81 outer plate
82 outer plate
83 inner plate
84 inner plate
90 end plate
91 welded connection
94 seal
100 end plate
101 locating keys
107 first channel
108 first space
112 second channel
117 third channel
119 additional wall
124 spacing rivets

What is claimed is:

1. A torque transfer device, in particular in the power train of a motor vehicle, for transferring torque between a drive unit (3) and a shaft that is rotatable around an axis of rotation (28), in particular a transmission input shaft, having a hydrodynamic torque converter (6), which comprises a converter cover (14) that is connectable to or connected to the drive unit (3), which converter cover may be coupled via an impeller (20) to a turbine wheel (21) to transfer torque, which turbine wheel is bridgeable, to transfer torque, by a torque converter lockup clutch (35), which includes a piston (64) that is movable to a limited extent in the axial direction and is constructed as a multi-plate clutch with a plate pack (80) that includes outer plates (81, 82) which are connected to an outer plate carrier (36) in a rotationally fixed connection, and inner plates (83, 84) which are connected to an inner plate carrier (34) in a rotationally fixed connection, wherein the plate pack (80) has, on the side facing away from the piston (64), an end plate (90, 100) that is fixed relative to the outer plate carrier (36), which serves to transfer torque and is tightly connected to the outer plate carrier (36).

2. The torque transfer device according to claim 1, wherein the end plate (90, 100) is attached to an output part (38) of a torsional vibration damping device which is connected ahead of the torque converter lockup clutch (35).

3. The torque transfer device according to claim 2, wherein the end plate (90, 100) is supported in the axial direction on the output part (38) of the torsional vibration damping device.

4. The torque transfer device according to claim 3, wherein the end plate (90, 100) is connected to the outer plate carrier (36) and/or the output part (38) in a rotationally fixed connection.

5. The torque transfer device according to claim 4, wherein the end plate (90) is connected to the outer plate carrier (36) and/or the output part (38) by material bonding.

6. The torque transfer device according to claim 5, wherein the end plate (90) is connected to the outer plate carrier (36) and/or the output part (38) by material bonding.

7. The torque transfer device according to claim 4, wherein the end plate (100) is crimped to the outer plate carrier and/or the output part (38).

8. The torque transfer device according to claim 4, wherein the end plate (90, 100) is connected to the outer plate carrier (36) and/or the output part by roller burnishing.

9. The torque transfer device according to claim 2, wherein the end plate (90, 100) has a profiled outer diameter.

10. The torque transfer device according to claim 2, wherein the end plate (90, 100) is connected to the outer plate carrier (36) by frictional or positive connection.

11. The torque transfer device according to claim 2, wherein a gasket (94), in particular a plastic gasket, a paper gasket, a metal gasket or a light metal gasket, is situated between the end plate (90) and the outer plate carrier (36).

12. The torque transfer device according to claim 2, wherein the end plate (100) has embossing and/or dishing radially on the inside or outside.

13. The torque transfer device according to claim 2, wherein the outer plate carrier (36) is situated in the axial direction between the output part (38) and the end plate (90, 100).

14. The torque transfer device according to claim 1, wherein the torsional vibration damping device includes a first torsional vibration damper (40) which acts between the converter cover (14) and the output part (38), and a second torsional vibration damper (25) which acts between the turbine wheel (21) and the shaft (28).

15. The torque transfer device according to claim 1, wherein the hydrodynamic torque converter (6) includes a three-channel system, through which the operation of the torque converter lockup clutch (35) is controlled.
